(19) United States
(12) Patent Application Publication
(10) Pub. No.: US 2008/0191378 A1
(43) Pub. Date: Aug. 14, 2008

(54) Microsphere reinforcement of composite materials

(76) Inventor: Brian Paul, Rochester Hills, MI (US)

Correspondence Address: BRANDON N. SKLAR. ESQ. (PATENT PROSECUTION);KAYE SCHOLER, LLP, 425 PARK AVENUE, NEW YORK, NY, 10022-3598, US

(21) Appl. No.: 11/705,786

(22) Filed: Feb. 14, 2007

(51) Int. Cl. C08L 93/00

(52) U.S. Cl. 264/122; 106/242

(57) ABSTRACT

Embodiments of the invention include a method by which particulate reinforcement is applied to dry fiber via a powder coating or a “dusting” process and subsequently infused with a resin before or after forming a lay-up. Upon curing a composite lay-up, the particulate reinforcement may be randomly distributed through the laminate composite, forming a wear surface on one side. The application of dried bulk particulate may be applied to a fibrous sheet (or fiber reinforcement) such that the coupling of the particulate reinforcement to the fiber includes a mechanical and/or electrostatic process. Agitating the particulate reinforcement prior to being applied to the dry fiber may induce an electrostatic charge. Further, the particulate reinforcement may include raw microspheres of different types and styles, such as organic, inorganic, unexpanded, pre-expanded, etc.

### FIELD OF THE INVENTION

Embodiments of the present invention relate to reinforcement of composite materials by applying microspheres to dry fiber prior to curing the fiber in a liquid matrix.

### BACKGROUND OF THE INVENTION

Material sciences related to composite materials have revolutionized the construction and assembly of everyday items. Composite materials, which generally refer to a polymer matrix reinforced with a fiber material, have been used, for example, in the production of various items such as bicycles, vehicles, and airplanes. Such manufactured goods are increasingly relying on large quantities of composite materials in order to reduce weight and/or increase strength. Furthermore, as composite technology has improved, the mechanical properties of composites have been tailored for specific applications. For example, the lay-up and direction of the fibers in a composite material may be chosen in order to maximize specific mechanical properties, such as maximizing tensile strength in a desired direction. Various known methods of reinforcing polymer materials with fibers have be used to customize the physical properties of composites, such as tensile strength, tensile and flexural modulus, impact strength, resistance to shrinking during cure, and other material properties.

Polymer materials have also been reinforced using particulates or microspheres. For example, in applications where the thermal properties of the composite require special attention, the addition of particles or microspheres has been used to manipulate the dimensional stability of the composite. Particles, mixed in the laminate or polymer matrix, have been employed to control the isotropic coefficient of thermal expansion and shrinkage properties of a composite. Also, light-weight particles, such as hollow spheres, have been incorporated as fillers into the polymer matrix to reduce the density of the laminate and the overall weight of a composite piece. Unfortunately, the incorporation of microspheres or particles into a polymer matrix is typically achieved at the expense of other laminate mechanical properties and manufacturing processes.

In particular, mixing of microspheres with a laminating resin prior to application to the fiber increases the resin's viscosity, resulting in poor resin infusion to a fibrous mat or prolonged infusion times exceeding resin pot life and inducing added stress and deterioration of the laminating mechanism. For example, the conventional method of applying microsphere reinforcement to the continuous fiber reinforced polymer matrix laminates results in poor fiber-matrix adhesion due to the inhibitive nature of a densely woven or packed reinforcement mat with the inclusion of microsphere particulate. That is, the resin flow front during infusion may be inhibited by microspheres taking up volume in which a liquid resin may typically flow, prohibiting resin from efficiently wetting out fibrous reinforcement through thickness. The resultant laminate may contain a fraction of total theoretical laminate properties due to the poor fiber-matrix inter-phase and/or interface. An example of such degraded resultant properties may be interlaminar shear strength.

The U.S. Pat. No. 4,818,583 attempts to address the negative effects of mixing the microspheres in the resin prior to application by impregnating microspheres into a fibrous web lay-up or laminate prior to application of the liquid resin. However, this method of applying the microspheres includes pressing or impregnating a foam paste, which contains the microspheres, into the fibrous lay-up using a screen printing apparatus. The use of foam paste in correlation with a screen printing apparatus limits the user to changing or adjusting raw material (resin) states from a low viscosity liquid to higher viscosity paste, potentially causing laminate property and infusion issues.

Similarly, U.S. Pat. No. 5,292,578 attempts to address this issue by applying microspheres to a fibrous web by advancing the fibrous web lay-up through a bath of an aqueous suspension that contains unexpanded microspheres, prior to application of the liquid resin. The method also requires subsequent heat treatment to expand microspheres to obtain final laminate properties, increasing the time, effort, and equipment involved in manufacturing a final product. Additionally, U.S. Pat. No. 5,292,578 uses a warp thread system of zero twist multifilament fibers and weft thread system with twist between 300 and 2000 turns per meter in a woven web in which warp thread skips two weft threads with microsphere content by volume between 60 to 100%. This process specificity limits a user to specific weave styles, reinforcement volumes, and thread manufacturers.

### SUMMARY OF THE INVENTION

Embodiments of the invention include a method of reinforcing composite material applying dry particles to a plurality of dry fibers and stacking the plurality of dry fibers with the applied dry particles to form a lay-up. The lay-up may be infused with resin and cured to form a composite structure. In another embodiment of the invention, a method of forming a reinforced wear surface on a composite structure may include applying dry particles to at least one of a plurality of dry fibers and stacking the plurality of dry fibers after applying the dry particles to form a lay-up. The method may also include infusing the lay-up with resin under pressure or vacuum to concentrate at least some of the particles along a wear surface and curing the resin to form a composite structure having one side configured as the wear surface. The particles may be configured to reinforce the wear surface of the composite structure.

Embodiments of the invention may also include a method of fabricating a resin impregnated ply for use in forming a composite structure. The method may include assembling a plurality of fibers to form a ply, applying dry particles to the ply such that at least some of the dry particles are in contact with at least some of the plurality of fibers, impregnating the ply with resin, and partially curing the resin. Another embodiment of the invention may include a resin impregnated ply. The ply may include a sheet, defined by a plurality of fibers, and a plurality of dry particles in contact with at least some of the plurality of fibers. The dry particles may be coupled to at least some of the plurality of fibers by an electrostatic force.

Another embodiment of the invention may include a resin impregnated ply for use in fabricating a composite material. The ply may include a sheet defined by a plurality of fibers, a plurality of particles substantially positioned on one side of the ply, and partially cured resin encasing the plurality of fibers and the plurality of particles.

### BRIEF DESCRIPTION OF THE DRAWINGS

FIG. 1 schematically illustrates a side view of a composite laminate in accordance with embodiments of the invention;

FIG. 2 schematically illustrates a system for incorporating particulate reinforcement onto fiber reinforcement in accordance with an embodiment of the invention;

FIG. 3 schematically illustrates a fiber reinforcement stack up including particulate reinforcement in accordance with yet another embodiment of the invention; and

FIG. 4 schematically illustrates the infusion of resin into the stack up of FIG. 3;

FIG. 5A schematically illustrates a method of fabricating a composite laminate in accordance with an embodiment of the invention;

FIG. 5B schematically illustrates another method of fabricating a composite laminate in accordance with another embodiment of the invention;

FIG. 6 shows a chart illustrating the basic wear, impact properties, and mechanical properties of a traditional composite laminate and a composite laminate in accordance with embodiments of the invention;

FIG. 7 schematically illustrates a cross section of an example of a composite laminate in accordance with embodiments of the invention;

FIG. 7A schematically illustrates a magnified view of section A shown in FIG. 7;

FIG. 7B schematically illustrates a magnified view of section B shown in FIG. 7; and

FIG. 8 illustrates the cure profiles for a resin system without particulate reinforcement and a resin system pre-mixed with 15% (by volume) particulate reinforcement.

### DESCRIPTION OF THE PREFERRED EMBODIMENTS

In accordance with embodiments of the invention, particulate reinforcement or microspheres may be applied to a dry fiber material through a powder coating, or “dusting” process, and subsequently the dry fiber material and applied microspheres are infused with a liquid resin. As used herein, the term “resin” is meant to include epoxy resins and other known matrix materials used in the fabrication of composite structures. The method distributes the microspheres through the entire structure, increasing toward a wear surface or laminate face. This ensures microsphere reinforcement resides in the cured laminate towards a desired laminate face, demonstrating improved impact and abrasion resistance at that laminate face. In a generic sense, this functionality ensures mechanical properties in the laminate cross section where desired, for example, improved impact resistance at a specified laminate surface, and at least maintained mechanical properties in the laminate bulk. Composite structures, produced in accordance with embodiments of the invention, may exhibit lower density and improved impact and abrasion strength while, at the same time, limiting manufacturing burden and lifetime structural ownership costs. It should be understood that embodiments of the invention include incorporating microspheres onto the fibrous material before liquid resin infusion and laminate consolidation, which allows the resin to maintain the necessary viscosity for accurate and predictable infusion processes.

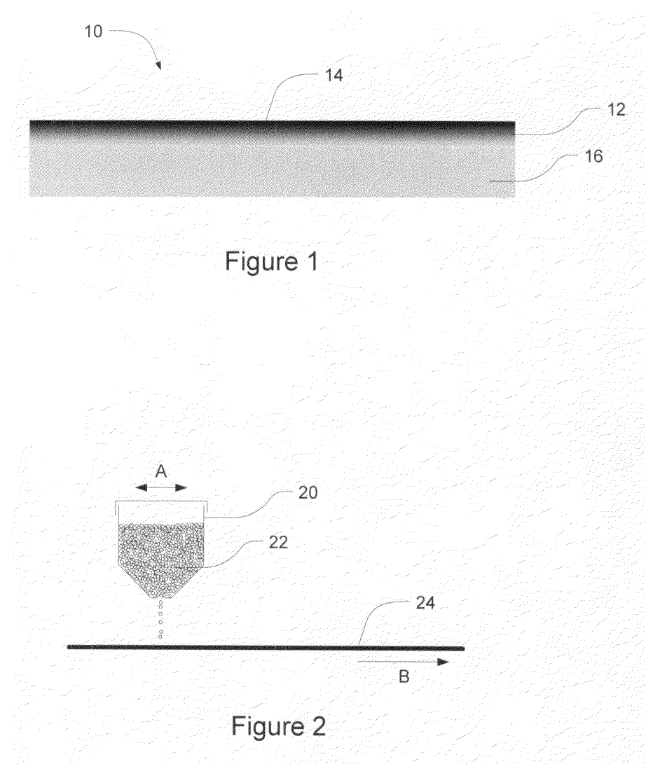

FIG. 1 schematically shows a side view of a composite laminate 10 made in accordance with an embodiment of the invention. The composite laminate 10 includes a particulate reinforced section 12 near the laminate wear surface 14 with high concentrations of particulate or microsphere reinforcement. The composite laminate 10 also includes a fiber reinforced section 16 that may be include microsphere reinforcement in lower concentrations than the particulate reinforcement section 12. In section 16, the microsphere reinforcement may decrease by volume in accordance with its distance from the laminate wear surface 14. The composite laminate 10 shown in FIG. 1 may be used in an application in which a single laminate surface requires improved impact, abrasion, and erosive wear properties, such as military ground vehicle primary structures and structural appendages, wearable layers for survivability components, fiber reinforced marine and aerospace impellers and propellers, and wind turbine propeller components.

Embodiments of the invention may be applied to a selection of diverse microsphere materials with various fiber reinforcement types, styles, and orientations, based on design requirements. Mechanical properties of both particulate and fiber reinforcement can be tailored to meet requirements. By applying particulate reinforcement before resin infusion, the user is not limited by resin pot life or low viscosity profiles. Additionally, the application of particulate reinforcement may occur before, during, and/or after the fiber weaving process to accommodate many manufacturing styles and/or proprietary processes. For example, this process may be successfully embraced at various stages of the composite's supply chain including fiber manufacturers applying particulate reinforcement after fiber spinning and heat treating, textile manufacturers applying particulate reinforcement to woven fibrous mats, or an end user applying particulate reinforcement in batches before cutting and processing woven textiles or uni-directional tapes. Embodiments of the invention may apply to any situation in which liquid resin is introduced to fibrous reinforcement and cured under heat and pressure regardless of shape, complexity or raw material (fibrous reinforcement and resin) selection.

The particulates or microspheres employed in accordance with embodiments of the invention may include ultra-high compression strength microsphere particulate such as ceramic grade microspheres from 3M in St. Paul, Minn., Hy-Tech in Melbourne, Fla., or Mo-Sci Corporation in Rolla, Mo. Other particulate materials may also be used in order to manipulate the properties of the particulate reinforcement section 12. For example, particulate reinforcement may be pre-expanded or unexpanded polymer based microspheres from manufactures such as Expancel Inc. in Duluth, Ga., and Bangs Laboratories in Fishers, Ind. Such alternative materials allow flexibility in attaining impact and abrasion resistant properties necessary to meet design requirements.

Embodiments of the invention may be used with both organic fibers (such as aramid fiber, carbon fiber, graphite fiber, and polymer fibers) and inorganic fibers (such as glass fiber, ceramic fiber, and metallic fiber). In fact, multiple fiber reinforcement materials and weave styles may be used in a single sheet. The fiber material used in the laminate 10 may include popular styles such as twills, woven rovings, basket weaves or other textile forms of fiber material, such as Kevlar®, graphite or carbon, glass, and polymer fiber reinforcement or the like. The type and style of the fiber reinforcement may be selected based on desired properties of the resultant composite structure. In some instances, multiple fiber materials may be used in a single structure. In addition, fiber tape may be used.

Additionally, matrix or resin materials may be selected in a similar manner, based on desirable material properties of the final structure. The resin or matrix material for the composite laminate 10 shown in FIG. 1 may include many thermoset systems including epoxy, BMI, polyester, vinyl ester, or phenolics. Other resins may be used depending on the desired properties of the resultant composite structure. Additionally, various additives may be incorporated into the matrix during mixing and application to improve smoke emissions, pot life, mechanical properties, etc. Such additives may include bromine, phosphorous, methylethylketone peroxide, silica, etc.

In accordance with embodiments of the invention, bulk particulate reinforcement may be applied or coupled to fiber reinforcement via a semi-controlled powder coating or “dusting” process prior to the application of resin to the fiber reinforcement. The powder coating or dusting process may use, for example, a particulate delivery mechanism, such as a hopper, to apply the particulate reinforcement directly to the fiber reinforcement. Other means of applying the particulate to the fiber reinforcement may also be used depending on the type of particulate and the manufacturing scale, such as a powder sifter or bulk mechanical screen equipment.

The microsphere reinforcement may be prepared for bonding using an atmosphere having less than 30% humidity to encourage the introduction of electrons (static energy) to the surface of the microsphere reinforcement. The process may vary depending on the particulate material used. Once applied to the fiber reinforcement, the microsphere reinforcement may attach to individual fibers and fiber tows by both electrostatic forces within the fiber sizing and mechanical forces within the bulk fibrous tow and woven nature of the fibrous textile. The small negative charge introduced through agitation in the particulate reinforcement provides a weak bond between the positively (or neutrally) charged fibrous reinforcement. In the case of insulating fibrous materials such as glass, mechanical forces may form the primary coupling for the particulate reinforcement.

Particulate reinforcement may include particles having a diameter of about 40 to about 100 microns. When applied to a fibrous reinforcement web or sheet, the particulate reinforcement may become mechanically entangled in the valleys and topography of the fibrous bundles (100-500 micron diameter) in both the collective direction within the textile reinforcement (lamina) or biased plies within the laminate. The microsphere/fiber coupling does not require a strong connection. In fact, a weak temporary union may be used to hold the microsphere reinforcement on the fiber material until the fiber reinforcement can be stacked and infused with resin. As would be apparent to those of skill in the art, the process may vary depending on the type of microsphere and fiber materials used.

FIG. 2 schematically illustrates the application of dry particulate reinforcement to dry fiber reinforcement prior to resin infusion in accordance with one embodiment of the invention. The microsphere or particulate reinforcement 22 may be placed into a particulate hopper 20, which may be positioned to distribute the microsphere reinforcement 22 onto the fabric reinforcement 24 that moves under the hopper 20 in the direction indicated by arrow B. As the particulate reinforcement 22 flows out of the hopper 20, the hopper 20 may be agitated, as shown by the arrow A, for example, to improve the flow of the particulate 22 out of the hopper 20 and to improve the electrostatic potential on the particulate 22. As shown in FIG. 2, the microsphere reinforcement 22 may be randomly placed onto the fibrous reinforcement 22. Excess particulate may be collected in a hopper below the fibrous reinforcement and reused or, in cases of prototype of small scale production, collected in a waste bin.

The fiber reinforcement 22 shown in FIG. 2 may include a discrete single sheet of fibrous material, a continuous tape of fibrous material, or multiple sheets in the form of a dry laminate. Laminates may consist of various combinations of fibrous materials and/or textile weaves, depending of design requirements of the laminate structure.

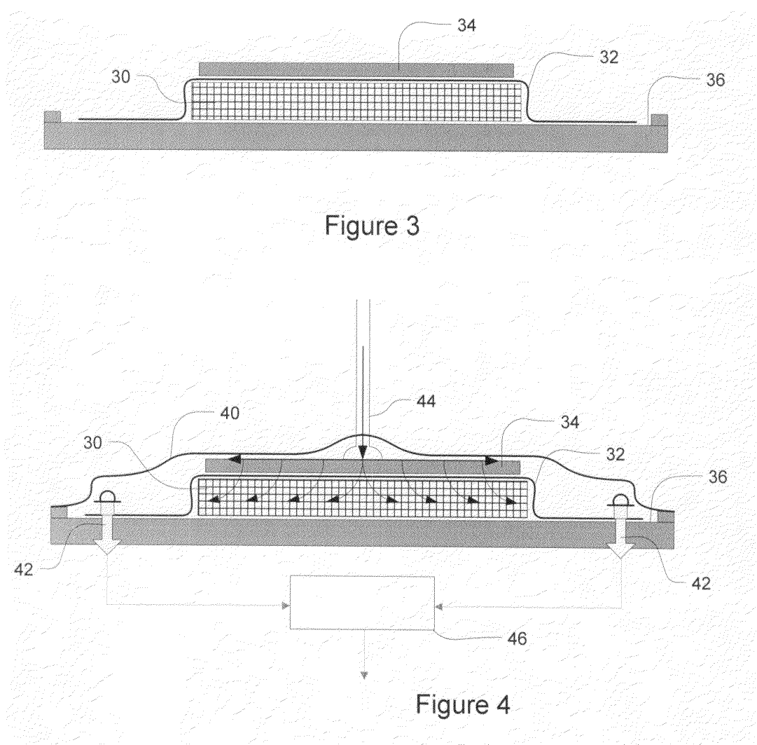

FIG. 3 schematically illustrates a fiber reinforcement stack up 30 in accordance with an embodiment of the invention where, once microsphere particulate is deposited on the fiber reinforcement, the fiber reinforcement may be stacked into a fiber/microsphere reinforcement stackup 30 or laminate prior to infusing the fiber reinforcement with resin. The fiber reinforcement may be stacked to the desired thickness or ply quantity for the resultant composite laminate structure and desired laminate properties. The fibrous reinforcement containing microspheres shall be placed on the vacuum side of the ply stack such that a liquid resin flow front interacts with the microsphere reinforced lamina during the infusion process. Fiber orientation within the lamina containing particulate reinforcement need not be altered from a typical lay-up “schedule” configured to meet typical design requirements. FIG. 3 also illustrates a distribution media 34 and a permeable release film 32 positioned on a tool 36. Fiber stack up 30 may be oriented to a desired schedule based on desired bulk laminate properties and thickness within infusion processing limits.

FIG. 4 schematically illustrates the compaction of the fiber/reinforcement stackup 30 shown in FIG. 3 and the infusion of resin with the flow of the liquid resin shown in arrows. FIG. 4 shows a setup for liquid resin infusion including release film 32, infusion media 34, tool 36, vacuum bagging film 40, vacuum ports 42, and resin inlet port 44. Under a vacuum generated by the generator 46 and by the force of gravity, liquid resin may flow down the inlet port 44 and then through the distribution media 34 and the permeable film 32. As liquid resin infuses the fiber stack up, the microsphere reinforcement detaches from the fiber and mechanically moves through the flow of resin. Resin flow efficiently distributes microspheres throughout the laminate thickness, decreasing through thickness inverse of the flow direction. The process may also use distribution media 34, such as Resin Flow 60 supplied by Airtech International Inc. in Huntington Beach, Calif., during the infusion process to help direct liquid resin flow initially across the surface of the dry consolidated ply stack up and subsequently through the thickness of the stackup 30 in an even flow front manner, forming a wear surface on the fiber stackup 30 adjacent to the tool 36. This mechanism of flow front control allows for even distribution of particulate reinforcement inverse to liquid resin flow direction through the fibrous reinforcement as the force of the flow front overcomes the mechanistic connection of the particulate/fibrous reinforcement interface. During the liquid resin infusion process, vacuum pressure may fall between about 22 in Hg and about 32 in Hg, for example.

Once the fiber/reinforcement stack up has been infused with resin, the fiber reinforcement, the microsphere reinforcement, and the resin may be cured. Cure cycles need not be altered simply due to the inclusion of particulate reinforcement within the bulk laminate. However, as understood by those of skill in the art, variations in cure cycles may be used when material limitations (pressure or temperature) of the particulate reinforcement preclude the use of some post-cure cycles. For example, the cure cycle may vary depending on the materials selected for design requirements.

Microsphere reinforcement may be applied to the dry fabric reinforcement in quantities ranging from about 3% to about 15% by resin volume, which has demonstrated improved mechanical performance, as discussed below. Devices, such as the particulate hopper 20 shown in FIG. 2, that include the ability to control the application rate, may be advantageous in accurately distributing the correct quantity (by volume) of particulate reinforcement placed onto the fiber reinforcement, based on fabric weave style, tow size, and fiber material type, and may also aid in limiting waste of microsphere reinforcement. The microsphere particulate application rates to achieve a finish quantity by resin volume of about 3% to about 15% are dependent on the desired resin volume fraction. Other resin/microsphere fractions may be used.

Significant “waste” of microsphere reinforcement presents cost issues related to recovery and recycling of waste microsphere reinforcement. Embodiments of the invention may be configured to overcome this waste issue by employing the electrostatic bonding between microsphere and fibrous reinforcement, effectively forcing a greater percentage of particulate matter to attach to the fibrous reinforcement during application, as opposed to falling into a waste receptacle below the fibrous mat. Additionally, the inclusion of electrostatic charging prohibits particulate reinforcement from becoming loose and falling away from the fibrous reinforcement during handling. Further, by tightly controlling the rate of microsphere reinforcement applied to the fiber, the quantity of wasted microsphere may be significantly reduced. By better controlling and understanding the actual quantity of particulate coupling to the fibrous mat, the user may better control particulate inputs from a hopper, so that processing allowables and wasting material are not exceeded. It is also contemplated that some of the waste particulate may be recycled.

The resultant composite laminate, as shown in FIG. 1 for example, are not limited to specific fibrous reinforcement weave styles or fibrous materials. Acceptable fibrous sheets or plies for use in accordance with embodiments of the invention may include conventional woven, non-woven, tri-axially woven, unidirectional or other fiber sheets as manufactured by Cytec Engineered Materials in Anaheim, Calif., for example. Additionally, fiber tape may be used as the fiber reinforcement. The fiber type may include materials such as aramid, fiberglass, graphite, polymer, or other fibers. Dissimilar fibrous materials woven together may also be used. It should be understood that some fibrous sheets, such as unidirectional fibrous sheets, for example, may be held together with a binder prior to or after the application of particulate reinforcement.

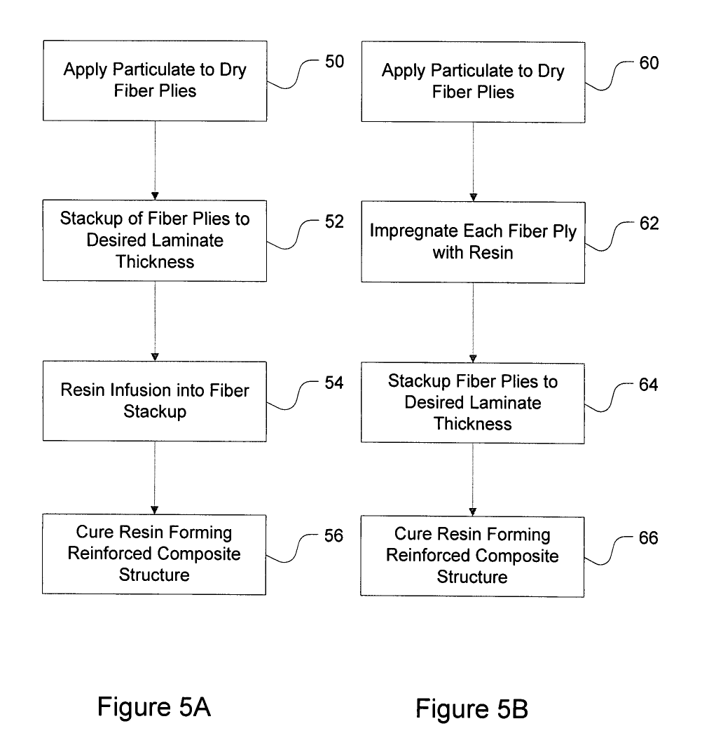

FIG. 5A illustrates a flow diagram describing a method for fabricating the composite laminate 10 shown in FIG. 1 in accordance with an embodiment of the invention. Step 50 includes the application of dry particulate reinforcement to the dry fiber. Once the particulate is applied to the fiber, the particulate coated fiber reinforcement, in step 52, may be cut, if necessary, and stacked into an appropriate lay-up “schedule” as discussed with reference to FIG. 3. It should be understood that the side of the fiber reinforcement to receive the particulate reinforcement may be oriented opposite the surface to first contact liquid resin during infusion (facing down in FIGS. 3 and 4). As discussed, the type of lay-up may be varied depending on the mechanical properties desired in the resultant composite.

In step 54, the fiber reinforcement stack with applied particulate reinforcement may be compacted and infused with resin, as shown in FIG. 4, using methods and a laminating system as known in the art. For example, typical resin transfer molding methods, as understood by those of skill in the art, may be employed to infuse resin into a dry fibrous stack under pressure or vacuum. Vacuum processes such as vacuum assisted resin transfer molding (“VARTM”), Seemen composites resin infusion molding process (“SCRIMP®”), channel assisted resin transfer molding (“CARTM”), and other like processes may be used. The infusion process may de-couple some of the particulate reinforcement temporarily attached to fibrous reinforcement and distribute the particulate reinforcement through the thickness of the laminate in a volume inverse to the liquid resin flow direction. In step 56, the resin, fiber stack up, and the particulate may be cured in order to set the resin into a solid form in accordance with methods and systems known to those of skill in the art.

It should be understood that an individual sheet or layer (lamina) of fibrous reinforcement may be processed independently by applying dry particulate reinforcement to the dry fiber reinforcement and then applying resin to form a pre-impregnated or “pre-preg” fiber sheet. Multiple pre-preg sheets may then be immediately stacked and molded to form a laminate composite using standard pre-preg systems and processes known to those of skill in the art. It is also contemplated that the resin in the pre-preg sheets may be partially cured such that the pre-preg sheets may remain stable for long periods of time, allowing pre-fabricated pre-preg sheets to be stacked and cured at a later time and or location to form a laminate composite 10, as shown in FIG. 1.

FIG. 5B illustrates a flow diagram describing a method for fabricating the composite laminate 10 shown in FIG. 1 from pre-preg sheets containing particulate reinforcement in accordance with an embodiment of the invention. As with Step 50 in FIG. 5A, Step 60 includes the application of dry particulate reinforcement to the dry fiber plies. In Step 62, each particulate coated fiber ply may be impregnated with resin to form a pre-preg fiber sheet. The fiber sheets may be configured to be cut, if necessary, before or after the application of resin. Steps 60 and 62 may performed on various types of fibrous reinforcement, including fiber tape. It should be understood that the resin used in step 62 may vary depending on whether the impregnate fiber plies are to be immediately stacked and cured after application of the resin or whether the impregnated fiber plies will be stacked and cured at a later time, similar to the use of traditional pre-preg sheets fabricated by JD Lincoln in Costa Mesa, Calif., for example. In a pre-preg sheet or ply in accordance with embodiments of the invention, resin may be partially cured or “B-staged” once the fibrous sheets have been coated with particulate reinforcement and impregnated with resin. An example of a prep-preg resin system that may be used in accordance with embodiments of the invention include the L-952 high temperature epoxy resin system available from JD Lincoln.

In step 64, the impregnated fiber plies may be stacked to form a lay-up of desired thickness. Step 66 includes curing the lay-up of impregnated fiber plies to form a laminate composite using pre-preg systems and methods known to those of skill in the art. Typically, pre-preg processes utilize an autoclave (pressurized oven) for compaction and cure under heat. It should be understood that the side of the fiber ply to receive the particulate reinforcement in step 60 may be oriented away from the lay-up tooling during an autoclave such that the particulate reinforcement is closer to a bleeder or breather installed under the vacuum bag. As such, during a typical autoclave cure process, the resin flow may flow toward the bleeder or breather, effectively dispersing particulate reinforcement to a wear surface. As understood by those of skill in the art, other autoclave configurations may be used. The concentration of particulate reinforcement at the wear surface may be less when using, in accordance with an embodiment of the invention, a pre-preg process than when using other resin transfer molding processes, such as VARTM. As discussed, the type of lay-up may be varied depending on the mechanical properties desired in the resultant composite.

Embodiments of the invention may be combined with various resin application processes. For example, the resin may be applied to a fibrous sheet as a liquid or as a solid, in the form of solid pellets or small granular pieces of solid resin. Once the granular pieces of solid resin are applied, a heat treatment may be applied to impregnate the sheet with resin. It should be understood that the particulate reinforcement and the resin in solid form, such as the granular pieces of resin, may be applied in any order or simultaneously, so long as the particulate reinforcement is applied prior to heating the solid resin or impregnating the fiber reinforcement.

The composite laminate discussed above and fabricated using the either method shown and described in reference to FIGS. 5A and 5B may include reductions in overall laminate weight and improvements in impact and abrasion strength, tensile strength, and flexural modulus. The composite laminate may additionally provide an improved robust composite structure that reduces lifetime ownership costs associated with maintenance and repair.

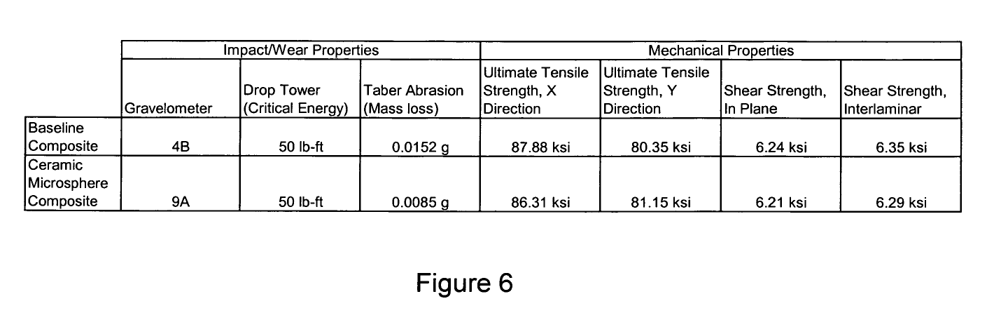

FIG. 6 includes a chart illustrating the basic wear/impact properties and mechanical properties of the composite laminate in accordance with an example of an embodiment of the invention. The results compare a conventional S-2 fiberglass/Epoxy laminate (entitled “Baseline Composite”) with an S-2 fiberglass/Epoxy laminate containing 15% ceramic microsphere reinforcement (entitled “Ceramic Microsphere Composite”) by resin volume fabricated in accordance with embodiments of the invention. During testing, the S-2 Fiberglass Baseline and the Ceramic Microsphere panels endured repeated low velocity impact events, a discrete drop tower impact event, and continuous taber abrasion events. Test coupons for each test complied with SAE J400-02, ASTM D 7136, and ASTM F 1978.

Significant improvement in low energy (low velocity) wear resistance of the Ceramic Microsphere panel was observed over the baseline laminate. For example, Gravelometer testing (SAE J400) yielded improved indentation depth and quantity in the ceramic reinforced laminate, over the baseline. In accordance with test sample evaluation procedures outlined in SAE J400, a number-letter designation of 9A was given to the Ceramic Microsphere panel, illustrating a significant improvement over the number-letter designation of 4B given to the baseline panel. The resultant letter designates the chip sizes being counted, and the number designates the number of chips of that size. Similarly, using mechanical abrasive testing (Taber Abrasion, ASTM F 1978), the Ceramic Microsphere panel yielded a substrate mass loss of 0.0085 g, which was significantly reduced from the substrate mass loss of 0.0152 g for the baseline. As for the fundamental mechanical properties shown in FIG. 6, no degradation was observed between the Ceramic Microsphere panel and the S-2 Fiberglass Baseline for the ultimate tensile strength test, X direction (ASTM D 3039), the ultimate tensile strength test, Y direction (ASTM D 5083), the shear strength test, in plane (ASTM D 5739), and the shear strength test, inter-laminar (ASTM D 5379).

Processing evaluations and microscopic analysis of microsphere reinforced composite laminates reveals consistent in plane dispersion of microsphere reinforcement onto fiber reinforcement through the dusting process. The in plane dispersion yields a robust product from a production perspective because infusion processing steps are not affected on a macro-scale. Identical steps may be employed in preparing and infusing the fibrous reinforcement with liquid resin regardless of whether particulate reinforcement is included in the laminate stack up. As such, according to embodiments of the invention, users may employ the application of particulate reinforcement in collaboration with standardized liquid resin infusion techniques. Additionally, existing production lines or facilities may be used in accordance with embodiments of the invention with little or no alteration except to apply discrete raw material inputs. Furthermore, the wear surface thickness may be adjusted to tailor the durability and strength of the resultant composite laminate structure, improving the customized nature of the composite product. This may be done by controlling the quantity of pre-coated lamina in a stacking sequence.

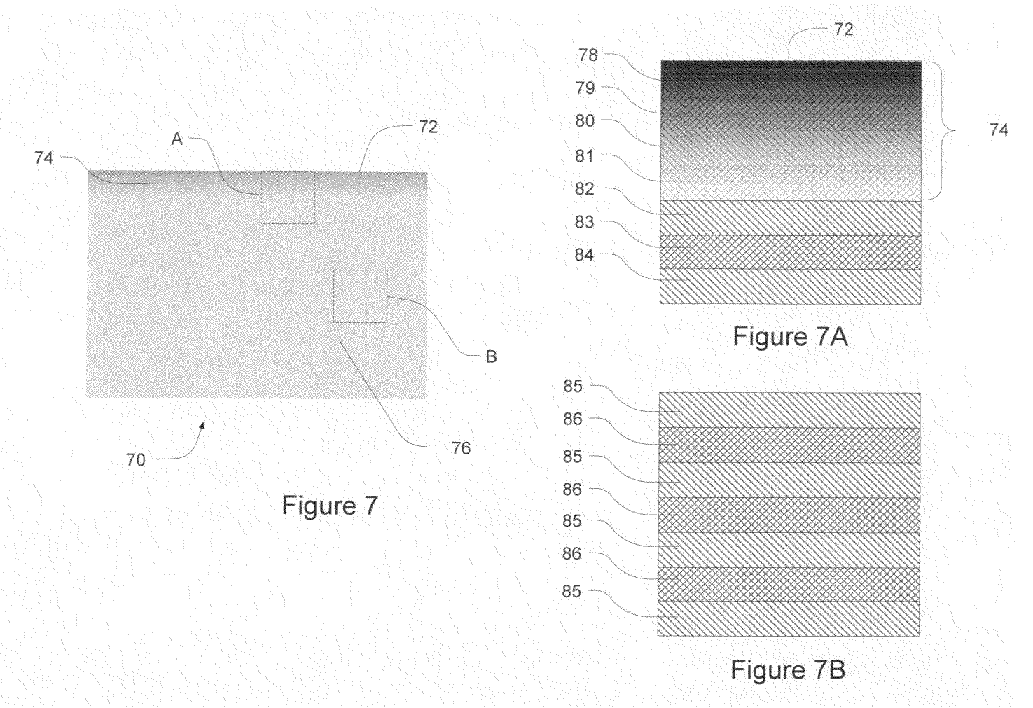

FIG. 7 schematically depicts a cross-section view of an example of a composite laminate 70 having a wear surface 72, a particulate reinforcement section 74 and a fiber reinforcement section 76. FIG. 7A schematically shows a magnified view of a section A, shown as a dashed section on FIG. 7. Likewise, FIG. 7B schematically shows another magnified view of section B, shown as a dashed section on FIG. 7.

FIG. 7A schematically shows the dispersion of particulate reinforcement in the particulate reinforcement section 74 across top ply 78 and fiber plies 79, 80, and 81, displaying a higher particulate concentration by volume at the wear surface 72 of the laminate. As shown in FIG. 7A, the concentration of particulate reinforcement decreases in the downward direction or the opposite direction of the resin flow during infusion shown in FIG. 4. The particulate reinforcement section 74 includes a darker (black) region at the wear surface 72 that transitions to a lighter grey across fiber plies 78, 79, 80, and 81. The fiber plies 82 and 83 also include a distributed amount of particulate reinforcement but do not exhibit the high concentrations seen in the particulate reinforcement section 74.

FIG. 7B schematically shows an example of a section of the fiber reinforcement section 76. As with fiber plies 82 and 83, FIG. 7B also shows fiber ply 85 and fiber ply 86, representing random plies in the fiber reinforcement section 76. Fiber play 85 may be oriented differently in the stackup than fiber ply 86. Additionally, the fiber plies 85 and 86 include a distributed amount of particulate reinforcement less than the concentrations shown in the particulate reinforcement section 74. The fiber reinforcement section 76 in FIG. 7 may include various numbers of fiber plies and may be customized by direction and number as understood by those of skill in the art.

It should be understood that the ability to tailor wear layers to input loads may be accomplished by adjusting the quantity of particulate reinforced lamina placed into the fibrous stack up before infusion. For example, laminates that experience high impact energies may be modified to include an increased percentage of particulate reinforcement by volume. This may be accomplished by applying additional particulate reinforcement to the dry fiber reinforcement. Additionally, the amount of particulate reinforcement may be increase in a finished composite article by including additional plies with particulate reinforcement to the stack up.

Consistent with the mechanical characterization of materials produced in accordance with embodiments of the invention, void content has been shown to decrease with the inclusion of microsphere reinforcement, enhancing the ultimate performance of the structural laminate. As understood by those of skill in the art, voids in composite laminate are generally undesirable as they may cause stress concentrations and act as crack initiators. The reduction of voids within a particulate reinforced laminate may therefore improve the durability and ultimate performance characteristics of the laminate, as described in FIG. 6. During infusion, particulate reinforcement may slide between fibrous reinforcement due to mechanical interaction with liquid resin flow and pressure change, displacing air or volatiles typically trapped in the stack up during infusion and cure.

As understood by those of skill in the art, it is possible that the inclusion of additional materials within a specific resin system may adversely affect the cure profile outlined by a resin manufacturer. Using differential scanning calorimetry (DSC), cure kinetics were determined for an epoxy resin system without microsphere and an epoxy resin system pre-mixed with 15% microspheres by volume. The cure profiles indicated degraded effects when pre-mixing microsphere reinforcement with an epoxy resin system. The heat release of reaction, dH, was 160 J/g for the resin without microsphere reinforcement and 157 J/g for the resin with 15% microsphere reinforcement, suggesting degraded thermal stability, or decreased glass transition temperature. In contrast, the method of incorporating microsphere reinforcement onto the fiber reinforcement prior to resin infusion avoids this degradation of cure profile, allowing the dH during cure to correlate with that of the resin without microsphere reinforcement. Therefore, embodiments of the invention disclosed herein avoid problems of “pre-mixed” reinforcement strategies of the prior art, providing optimal resin viscosity, infusion times, and resin-fiber adherence. The glass transition temperature (Tg) is defined as the approximate temperature at which increased molecular mobility results in significant changes in properties of a cured resin. The advantage of an increased Tg is a higher working temperature allowable for the composite laminate.

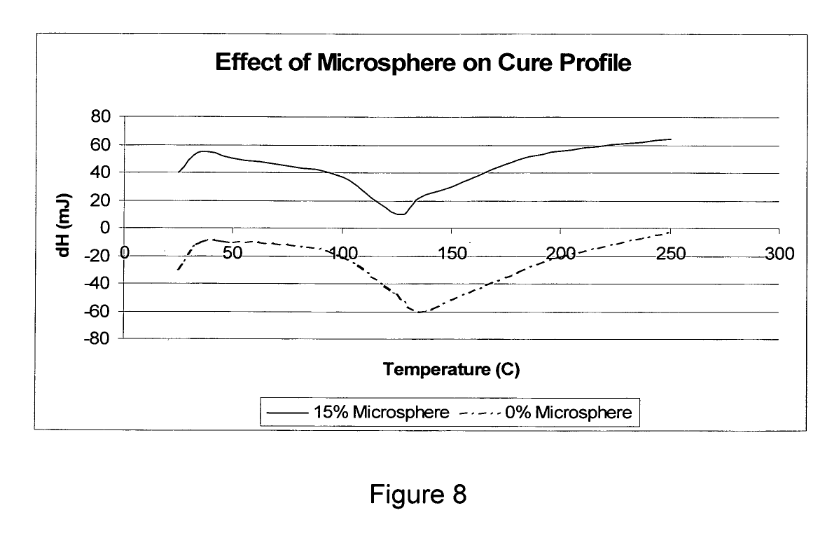

FIG. 8 illustrates limited heat release of reaction effects when including particulate reinforcement within the fibrous stack up during infusion and cure. The heat release of reaction (y-axis) is 160 J/g for 0% ceramic (resin only) and 157 J/g for 15% ceramic over the cure profile (temperature, x-axis) of the laminate.

In accordance with other embodiments of the invention, only some plies in a multi-ply laminate may include applied particulate reinforcement. For example, it is contemplated that the top four plies shown in FIG. 7 as section 74 may include applied particulate reinforcement while the other plies included no particulate reinforcement. The number of plies including particulate reinforcement may be adjusted depending on the desired concentration or thickness of the particulate section 74 after cure.

The embodiments described herein are examples of implementations of the invention. Modifications may be made to these examples without departing from the scope of the invention, which is defined by the claims, below.

What is claimed is:

1. A method of reinforcing composite material, the method comprising:
applying dry particles to at least one of a plurality of dry fibers;
stacking the plurality of dry fibers with the applied dry particles to form a lay-up;
applying resin to the plurality of dry fibers; and
curing the resin to form a composite structure.

2. The method of claim 1, further comprising coupling at least some of the dry particles to the at least one of the plurality of dry fibers by an electrostatic force.

3. The method of claim 2, further comprising generating an electrostatic charge on the at least some of the dry particles for coupling to the at least one of the plurality of dry fibers.

4. The method of claim 3, further comprising agitating the dry particles to induce the electrostatic charge prior to applying the dry particles.

5. The method of claim 3, comprising generating the electrostatic charge on the dry particles in an atmosphere having less than about 30% humidity.

6. The method of claim 1, wherein applying the resin comprises infusing the lay-up with the resin after stacking the plurality of dry fibers with the applied dry particles to form the lay-up.

7. The method of claim 6, wherein infusing the lay-up with resin comprises concentrating a plurality of the particles adjacent to a wear surface of the composite structure.

8. The method of claim 7, comprising applying a quantity of the particles ranging from about 3% to about 15% by a resin volume.

9. The method of claim 8, wherein applying the dry particles includes applying ceramic microspheres.

10. The method of claim 8, wherein applying the dry particles includes applying polymer microspheres.

11. The method of claim 8, comprising applying at least one of unexpanded or pre-expanded particles.

12. The method of claim 7, comprising infusing the lay-up under at least one of vacuum or pressure.

13. The method of claim 1, wherein applying the resin comprises impregnating the plurality of dry fibers and applied dry particles with the resin prior to stacking the plurality of dry fibers with the applied dry particles to form the lay-up.

14. The method of claim 1, comprising applying the dry particles by at least one of a hopper, a powder sifter, or a mechanical screen.

15. The method of claim 1, wherein applying the dry particles includes applying the dry particles to at least one of the plurality of dry fibers comprising at least one of organic fibers or inorganic fibers.

16. A method of forming a reinforced wear surface on a composite structure, comprising:
applying dry particles to at least one of a plurality of dry fibers;
stacking the plurality of dry fibers and the applied dry particles to form a lay-up;
infusing the lay-up with resin under at least one of pressure or vacuum to concentrate at least some of the particles along a wear surface; and
curing the resin to form a composite structure having one side configured as the wear surface;
wherein the particles are configured to reinforce the wear surface of the composite structure.

17. The method of claim 16, further comprising coupling at least some of the dry particles to the at least one of the plurality of fibers by an electrostatic force.

18. The method of claim 17, further comprising generating an electrostatic charge on the at least some of the dry particles for coupling to the at least one of the plurality of dry fibers.

19. The method of claim 18, wherein generating the electrostatic charge includes agitating the dry particles to induce the electrostatic charge.

20. The method of claim 16, comprising applying a quantity of the dry particles ranging from about 3% to about 15% by a resin volume.

21. The method of claim 16, comprising applying dry particles made from at least one of ceramic or polymer.

22. The method of claim 16, comprising applying at least one of unexpanded or pre-expanded dry particles.

23. The method of claim 16, wherein applying the dry particles includes applying the dry particles to at least one of a plurality of fibers made from at least one of organic fibers or inorganic fibers.

24. A method of fabricating a resin impregnated ply for use in forming a composite structure, the method comprising:
assembling a plurality of fibers to form a ply;
applying dry particles to the ply such that at least some of the dry particles are in contact with at least some of the plurality of fibers;
impregnating the ply with resin; and
partially curing the resin.

25. The method of claim 24, further comprising:
applying the resin to the ply in a solid form; and
melting the resin in solid form to impregnate the ply with the resin.

26. The method of claim 25, wherein applying the resin to the ply in a solid form occurs simultaneously with applying the dry particles to the ply.

27. The method of claim 25, wherein applying the resin to the ply in a solid form occurs prior to applying the dry particles to the ply.

28. The method of claim 25, wherein applying the resin to the ply in a solid form occurs after applying the dry particles to the ply.

29. The method of claim 24, further comprising coupling at least some of the dry particles to the at least one of the plurality of dry fibers by an electrostatic force prior to impregnating the ply with resin.

30. The method of claim 29, further comprising generating an electrostatic charge on the at least some of the dry particles for coupling to the at least one of the plurality of dry fibers.

31. The method of claim 30, further comprising agitating the dry particles to induce the electrostatic charge prior to applying the dry particles.

32. The method of claim 30, comprising generating the electrostatic charge on the dry particles in an atmosphere having less than about 30% humidity.

33. A ply for use in fabricating a composite material comprising:
a sheet comprising a plurality of dry fibers; and
a plurality of dry particles in contact with at least some of the plurality of dry fibers;
wherein at least some of dry particles are coupled to the at least some of the plurality of dry fibers by an electrostatic force.

34. A resin impregnated ply for use in fabricating a composite material comprising:
a sheet comprising a plurality of fibers;
a plurality of particles; and
partially cured resin substantially encasing the plurality of fibers and the plurality of particles.

35. A method of forming a reinforced composite material, the method comprising:
stacking a plurality of plies to form a lay-up, each ply comprising:
a sheet comprising a plurality of fibers;
a plurality of particles; and
partially cured resin substantially encasing the plurality of fibers and the plurality of particles; and
curing the resin to form a composite structure.
